(19) United States
(12) Patent Application Publication
(10) Pub. No.: US 2024/0396395 A1
(43) Pub. Date: Nov. 28, 2024

(54) STATOR FOR ROTATING ELECTRIC MACHINE AND MOTOR-DRIVEN COMPRESSOR

(71) Applicant: KABUSHIKI KAISHA TOYOTA JIDOSHOKKI, Aichi-ken (JP)

(72) Inventors: Noriyuki SUZUKI, Kariya-shi (JP); Tomohiko YOSHIMURA, Kariya-shi (JP)

(73) Assignee: KABUSHIKI KAISHA TOYOTA JIDOSHOKKI, Aichi-ken (JP)

(21) Appl. No.: 18/650,352

(22) Filed: Apr. 30, 2024

(30) Foreign Application Priority Data
May 24, 2023 (JP) 2023-085575

(51) Int. Cl. H02K 3/34; H02K 1/16

(52) U.S. Cl. CPC H02K 3/345; H02K 1/165

(57) ABSTRACT

A stator for a rotating electric machine includes a stator core that includes multiple teeth extending from an inner circumferential surface of a cylindrical yoke, and multiple coils respectively provided around the respective teeth. A slot exists between teeth that are adjacent to each other in a circumferential direction of the yoke. The teeth each include a tooth extension having tooth side surfaces, which define the slots, and two flanges having flange surfaces that define the slots. An insulating member is arranged in each slot. The insulating members are each configured to support the corresponding coils in a state in which each coil is arranged at a radially outer side of a boundary between the corresponding tooth side surface and the corresponding flange surface.

### BACKGROUND

### 1. Field

The present disclosure relates to a stator for a rotating electric machine and to a motor-driven compressor.

### 2. Description of Related Art

A motor-driven compressor includes a rotary shaft, a rotating electric machine, a housing, and a compression mechanism. The rotating electric machine rotates the rotary shaft. The housing accommodates the rotating electric machine. The compression mechanism is driven by rotation of the rotary shaft. The compression mechanism compresses fluid. The rotating electric machine includes a stator.

Japanese Laid-Open Patent Publication No. 2019-126251 discloses a stator of a rotating electric machine that includes a stator core and coils. The stator core includes a cylindrical yoke and multiple teeth. The teeth extend from the inner circumferential surface of the yoke. The stator core includes slots each located between two of the teeth that are adjacent to each other in the circumferential direction of the yoke. Each coil is formed by a winding that is wound in a concentrated manner around the corresponding tooth while passing through the corresponding slots. Each tooth includes a tooth extension and two flanges. The tooth extension extends from the inner circumferential surface of the yoke. The two flanges project from the distal end of the tooth extension toward opposite sides in the circumferential direction of the yoke.

In the stator of such a rotating electric machine, leakage magnetic flux may be generated that flows from the inner circumferential surface of the yoke toward the flanges of the teeth after passing through the spaces between the coils that are adjacent to each other in the circumferential direction of the yoke. For example, if a part of a coil is located on a flange surface of each flange, which is a surface defining a slot, a leakage magnetic flux may flow through the part of the coil on the flange surface. The leakage magnetic flux generates eddy currents in the coil, causing the coil to generate heat. The heat generated by the coil lowers the output of the rotating electric machine. Therefore, it is desirable to suppress the generation of eddy currents in the coil caused by the leakage magnetic flux.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a stator for a rotating electric machine includes a stator core and multiple coils. The stator core includes a cylindrical yoke and multiple teeth extending from an inner circumferential surface of the yoke. The stator core includes slots each located between adjacent ones of the teeth in a circumferential direction of the yoke. The coils are respectively provided around the multiple teeth. Each coil is formed by a winding that is wound in a concentrated manner around the corresponding one of the teeth while passing through the corresponding slots. Each of the teeth includes a tooth extension extending from the inner circumferential surface of the yoke in a radial direction of the yoke, and two flanges projecting from a distal end of the tooth extension toward opposite sides in the circumferential direction of the yoke. The tooth extensions each include tooth side surfaces that are located on opposite sides of the tooth extension in the circumferential direction. The tooth side surfaces define the slots. Each of the flanges includes a flange surface that extends from the corresponding one of the tooth side surfaces to a distal end of the flange, the flange surfaces defining the slots. An insulating member is arranged in each of the slots. The insulating member is configured to support the corresponding coils in a state in which each coil is arranged at a radially outer side of a boundary between the corresponding tooth side surface and the corresponding flange surface.

In another general aspect, a motor-driven compressor includes a rotary shaft, a rotating electric machine configured to rotate the rotary shaft, a housing that accommodates the rotating electric machine, and a compression mechanism configured to be driven by rotation of the rotary shaft to compress a fluid. The rotating electric machine includes a stator. The stator includes a stator core and multiple coils. The stator core includes a cylindrical yoke and multiple teeth extending from an inner circumferential surface of the yoke. The stator core includes slots each located between adjacent ones of the teeth in a circumferential direction of the yoke. The coils are respectively provided around the multiple teeth. Each coil is formed by a winding that is wound in a concentrated manner around the corresponding one of the teeth while passing through the corresponding slots. Each of the teeth includes a tooth extension extending from the inner circumferential surface of the yoke in a radial direction of the yoke, and two flanges projecting from a distal end of the tooth extension toward opposite sides in the circumferential direction of the yoke. The tooth extensions each include tooth side surfaces that are located on opposite sides of the tooth extension in the circumferential direction. The tooth side surfaces define the slots. Each of the flanges includes a flange surface that extends from the corresponding one of the tooth side surfaces to a distal end of the flange, the flange surfaces defining the slots. An insulating member is arranged in each of the slots, the insulating member being configured to support the corresponding coils in a state in which each coil is arranged at a radially outer side of a boundary between the corresponding tooth side surface and the corresponding flange surface.

Other features and aspects will be apparent from the following detailed description, the drawings, and the claims.

### BRIEF DESCRIPTION OF THE DRAWINGS

FIG. 1 is a cross-sectional view of a motor-driven compressor according to an embodiment.

FIG. 2 is a perspective view of a stator of the motor-driven compressor shown in FIG. 1.

FIG. 3 is a cross-sectional view of the stator shown in FIG. 2.

FIG. 4 is an enlarged cross-sectional view of a portion of the stator shown in FIG. 3.

FIG. 5 is an enlarged cross-sectional view of a portion of the stator shown in FIG. 4.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

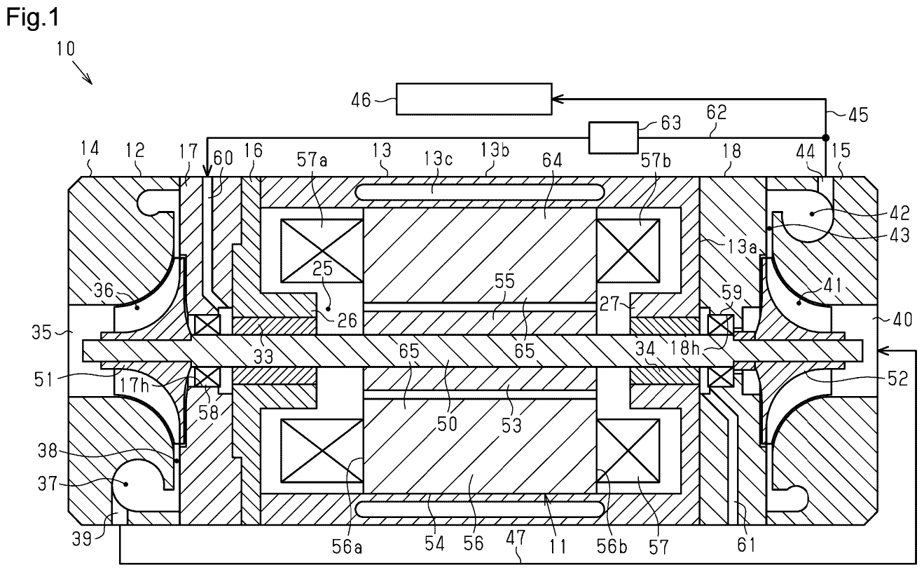

A stator 54 for a rotating electric machine 11 and a motor-driven compressor 10 according to one embodiment will now be described with reference to FIGS. 1 to 5. The stator 54 for the rotating electric machine 11 of the present embodiment is part of the motor-driven compressor 10. The motor-driven compressor 10 is a centrifugal compressor mounted on a fuel cell electric vehicle. The motor-driven compressor 10 compresses air, which is fluid.

### Basic Configuration of Motor-Driven Compressor

As shown in FIG. 1, the motor-driven compressor 10 includes the rotating electric machine 11 and a housing 12. The housing 12 includes a motor housing member 13, a first compressor housing member 14, a second compressor housing member 15, a first plate 16, a second plate 17, and a third plate 18. The motor housing member 13, the first compressor housing member 14, the second compressor housing member 15, the first plate 16, the second plate 17, and the third plate 18 are made of metal. The motor housing member 13, the first compressor housing member 14, the second compressor housing member 15, the first plate 16, the second plate 17, and the third plate 18 are made of, for example, aluminum.

The motor housing member 13 includes an end wall 13a and a peripheral wall 13b. The end wall 13a is, for example, disc-shaped. The peripheral wall 13b cylindrically extends from the outer periphery of the end wall 13a. The peripheral wall 13b includes a coolant passage 13c. The peripheral wall 13b of the motor housing member 13 is cooled by the coolant flowing through the coolant passage 13c.

The first plate 16 is, for example, disc-shaped. The first plate 16 closes an opening of the peripheral wall 13b of the motor housing member 13. The motor housing member 13 and the first plate 16 define a motor chamber 25. The housing 12 thus defines the motor chamber 25. The motor chamber 25 accommodates the rotating electric machine 11. The housing 12 thus accommodates the rotating electric machine 11.

The housing 12 includes a first bearing holding portion 26, which is an example of a bearing holding portion. The first bearing holding portion 26 projects from a center portion of the first plate 16 into the motor chamber 25. The first bearing holding portion 26 is cylindrical. The axis of the first bearing holding portion 26 agrees with the axis of the peripheral wall 13b. The first bearing holding portion 26 includes an inner hole that extends through the first plate 16 and opens in an end face of the first plate 16 on a side opposite to the motor housing member 13.

The housing 12 includes a second bearing holding portion 27, which is an example of a bearing holding portion. The second bearing holding portion 27 projects from a center portion of the end wall 13a of the motor housing member 13 into the motor chamber 25. The second bearing holding portion 27 is cylindrical. The axis of the second bearing holding portion 27 agrees with the axis of the peripheral wall 13b. Accordingly, the axis of the first bearing holding portion 26 and the axis of the second bearing holding portion 27 agree with each other. The second bearing holding portion 27 includes an inner hole that extends through the end wall 13a of the motor housing member 13 and opens in an end face of the end wall 13a on a side opposite to the peripheral wall 13b.

The second plate 17 is coupled to an end face of the first plate 16 on a side opposite to the motor housing member 13. The second plate 17 is attached to the first plate 16 with the thickness direction of the second plate 17 agreeing with the thickness direction of the first plate 16.

The second plate 17 includes a first insertion hole 17h. The first insertion hole 17h extends through a center portion of the second plate 17. The first insertion hole 17h is continuous with the inner hole of the first bearing holding portion 26. The axis of the first insertion hole 17h agrees with the axis of the first bearing holding portion 26.

The third plate 18 is coupled to an end face of the end wall 13a of the motor housing member 13 on a side opposite to the peripheral wall 13b. The third plate 18 is attached to the end wall 13a of the motor housing member 13 in a state in which the thickness direction of the third plate 18 agrees with the thickness direction of the end wall 13a of the motor housing member 13.

The third plate 18 includes a second insertion hole 18h. The second insertion hole 18h extends through a center portion of the third plate 18. The second insertion hole 18h is continuous with the inner hole of the second bearing holding portion 27. The axis of the second insertion hole 18h agrees with the axis of the second bearing holding portion 27.

The first compressor housing member 14 is tubular and includes a first suction port 35, which is a circular hole into which air is drawn. The first compressor housing member 14 is coupled to an end face of the second plate 17 on a side opposite to the first plate 16 in a state in which the axis of the first suction port 35 agrees with the axis of the first insertion hole 17h. The first suction port 35 opens in an end face of the first compressor housing member 14 on a side opposite to the second plate 17. Air that has been cleaned by an air cleaner (not shown) flows through the first suction port 35.

The motor-driven compressor 10 includes a first impeller chamber 36, a first discharge chamber 37, and a first diffuser passage 38. The first impeller chamber 36, the first discharge chamber 37, and the first diffuser passage 38 are provided between the first compressor housing member 14 and the second plate 17. The first impeller chamber 36 is continuous with the first suction port 35. The first discharge chamber 37 is located around the first impeller chamber 36 and extends about the axis of the first suction port 35. The first diffuser passage 38 connects the first impeller chamber 36 to the first discharge chamber 37. The first impeller chamber 36 is continuous with the first insertion hole 17h.

The motor-driven compressor 10 includes a first discharge passage 39. The first discharge passage 39 is formed in the first compressor housing member 14. A first end of the first discharge passage 39 is continuous with the first discharge chamber 37. A second end of the first discharge passage 39 opens in the outer peripheral surface of the first compressor housing member 14.

The second compressor housing member 15 is tubular and includes a second suction port 40, which is a circular hole into which air is drawn. The second compressor housing member 15 is coupled to an end face of the third plate 18 on a side opposite to the motor housing member 13 in a state in which the axis of the second suction port 40 agrees with the axis of the second insertion hole 18h. The second suction port 40 opens in an end face of the second compressor housing member 15 on a side opposite to the third plate 18.

The motor-driven compressor 10 includes a second impeller chamber 41, a second discharge chamber 42, and a second diffuser passage 43. The second impeller chamber 41, the second discharge chamber 42, and the second diffuser passage 43 are provided between the second compressor housing member 15 and the third plate 18. The second impeller chamber 41 is continuous with the second suction port 40. The second discharge chamber 42 is located around the second impeller chamber 41 and extends about the axis of the second suction port 40. The second diffuser passage 43 connects the second impeller chamber 41 to the second discharge chamber 42. The second impeller chamber 41 is continuous with the second insertion hole 18h.

The motor-driven compressor 10 includes a second discharge passage 44. The second discharge passage 44 is formed in the second compressor housing member 15. A first end of the second discharge passage 44 is continuous with the second discharge chamber 42. A second end of the second discharge passage 44 opens in the outer peripheral surface of the second compressor housing member 15.

A supply pipe 45 is connected to the second discharge passage 44. The supply pipe 45 is connected to a fuel cell stack 46. A first end of the supply pipe 45 is connected to the second discharge passage 44. A second end of the supply pipe 45 is connected to the fuel cell stack 46.

The motor-driven compressor 10 includes a connection pipe 47. A first end of the connection pipe 47 is connected to the first discharge passage 39. A second end of the connection pipe 47 is connected to the second suction port 40. Air discharged from the first discharge chamber 37 to the first discharge passage 39 flows through the connection pipe 47. The air that has passed through the connection pipe 47 is drawn into the second impeller chamber 41 through the second suction port 40.

The motor-driven compressor 10 includes a rotary shaft 50. The rotary shaft 50 extends across the motor chamber 25 in a state in which the axis of the rotary shaft 50 and the axis of the peripheral wall 13b agree with each other. A first end, which is one end in the axial direction, of the rotary shaft 50 projects into the first impeller chamber 36 from the inside of the motor chamber 25, through the inner hole of the first bearing holding portion 26 and the first insertion hole 17h. A second end, which is the other end in the axial direction, of the rotary shaft 50 projects into the second impeller chamber 41 from the inside of the motor chamber 25, through the inner hole of the second bearing holding portion 27 and the second insertion hole 18h.

The motor-driven compressor 10 includes a first impeller 51 and a second impeller 52. The first impeller 51 is coupled to the first end of the rotary shaft 50. The first impeller 51 is accommodated in the first impeller chamber 36. The first impeller chamber 36 thus accommodates the first impeller 51. The first impeller 51 rotates integrally with the rotary shaft 50 to compress air drawn into the first impeller chamber 36.

The second impeller 52 is coupled to the second end of the rotary shaft 50. The second impeller 52 is accommodated in the second impeller chamber 41. The second impeller chamber 41 thus accommodates the second impeller 52. The second impeller 52 rotates integrally with the rotary shaft 50 to compress air drawn into the second impeller chamber 41. The second impeller 52 rotates to compress the air that has been compressed by the first impeller 51.

As described above, the first impeller 51 and the second impeller 52 rotate integrally with the rotary shaft 50. The first impeller 51 and the second impeller 52 form a compression mechanism that is driven by rotation of the rotary shaft 50 to compress air.

The rotating electric machine 11 includes a rotor 53 and the stator 54. The rotor 53 is fixed to the rotary shaft 50. The rotor 53 includes a cylindrical rotor core 55, which is fixed to the rotary shaft 50, and permanent magnets (not shown), which are provided in the rotor core 55. The rotor 53 rotates integrally with the rotary shaft 50.

The stator 54 is fixed to the housing 12. The stator 54 is disposed on an outer side of the rotor 53. The stator 54 includes a cylindrical stator core 56 and coils 57.

The stator core 56 is fixed to the inner circumferential surface of the peripheral wall 13b of the motor housing member 13. The stator core 56 includes a first end face 56a and a second end face 56b. The first end face 56a is located on one side in the axial direction of the stator core 56. The second end face 56b is located on the other side in the axial direction of the stator core 56. The stator core 56 is disposed in the motor chamber 25 such that the first end face 56a faces the first plate 16 in the axial direction of the rotary shaft 50, and the second end face 56b faces the end wall 13a of the motor housing member 13 in the axial direction of the rotary shaft 50.

The coils 57 are installed in the stator core 56 in a wound state. The stator 54 includes coil ends. Specifically, the stator 54 includes first coil ends 57a and second coil ends 57b. The first coil ends 57a and the second coil ends 57b are parts of the coils 57. The first coil ends 57a project from the first end face 56a of the stator core 56 toward the first plate 16. The first bearing holding portion 26 projects into an inner region surrounded by the first coil ends 57a. The second coil ends 57b project from the second end face 56b of the stator core 56 toward the end wall 13a of the motor housing member 13. The second bearing holding portion 27 projects into an inner region surrounded by the second coil ends 57b.

The rotary shaft 50 rotates integrally with the rotor 53 when current flows through the coils 57 from a battery (not shown). The rotating electric machine 11 thus rotates the rotary shaft 50.

The motor-driven compressor 10 includes a first bearing 33 and a second bearing 34. The first bearing 33 is cylindrical. The first bearing 33 is a dynamic plain bearing. The first bearing 33 is held by the first bearing holding portion 26. The first bearing holding portion 26 thus holds the first bearing 33. The first bearing 33 supports the rotary shaft 50 such that the rotary shaft 50 is rotatable with respect to the first plate 16. The first bearing 33 is thus a bearing that rotatably supports the rotary shaft 50.

The second bearing 34 is cylindrical. The second bearing 34 is a dynamic plain bearing. The second bearing 34 is held by the second bearing holding portion 27. The second bearing holding portion 27 thus holds the second bearing 34. The second bearing 34 supports the rotary shaft 50 such that the rotary shaft 50 is rotatable with respect to the end wall 13a of the motor housing member 13. The second bearing 34 is thus a bearing that rotatably supports the rotary shaft 50. In this manner, the rotary shaft 50 is rotationally supported by the housing 12 with the first bearing 33 and the second bearing 34.

The motor-driven compressor 10 includes a first seal member 58. The first seal member 58 is provided between the inner peripheral surface of the first insertion hole 17h and the rotary shaft 50. The first seal member 58 restricts air leakage to the motor chamber 25 from the first impeller chamber 36 via the first insertion hole 17h and the inner hole of the first bearing holding portion 26. The first seal member 58 is, for example, a seal ring.

The motor-driven compressor 10 includes a second seal member 59. The second seal member 59 is provided between the inner circumferential surface of the second insertion hole 18h and the rotary shaft 50. The second seal member 59 restricts air leakage to the motor chamber 25 from the second impeller chamber 41 via the second insertion hole 18h and the inner hole of the second bearing holding portion 27. The second seal member 59 is, for example, a seal ring.

The air drawn into the first impeller chamber 36 through the first suction port 35 is delivered to the first diffuser passage 38 while being accelerated by rotation of the first impeller 51, and is then pressurized by passing through the first diffuser passage 38. The air that has passed through the first diffuser passage 38 is discharged to the first discharge chamber 37. The air discharged to the first discharge chamber 37 is discharged to the first discharge passage 39. The air discharged to the first discharge passage 39 is drawn into the second impeller chamber 41 through the connection pipe 47 and the second suction port 40. The air drawn into the second impeller chamber 41 is delivered to the second diffuser passage 43 while being accelerated by rotation of the second impeller 52, and is then pressurized by passing through the second diffuser passage 43. The air that has passed through the second diffuser passage 43 is discharged to the second discharge chamber 42. The air discharged to the second discharge chamber 42 is discharged to the second discharge passage 44. The air discharged to the second discharge passage 44 is supplied to the fuel cell stack 46 via the supply pipe 45. The motor-driven compressor 10 thus supplies air to the fuel cell stack 46. Oxygen contained in the air supplied to the fuel cell stack 46 contributes to power generation in the fuel cell stack 46.

The motor-driven compressor 10 includes an inflow passage 60. The inflow passage 60 is formed in the second plate 17. A first end of the inflow passage 60 opens in the outer circumferential surface of the second plate 17. A second end of the inflow passage 60 is continuous with a section of the first insertion hole 17h that is closer to the motor chamber 25 than the first seal member 58 is.

The motor-driven compressor 10 includes an outflow passage 61. The outflow passage 61 is formed in the third plate 18. A first end of the outflow passage 61 is connected to a section of the second insertion hole 18h that is closer to the motor chamber 25 than the second seal member 59 is. A second end of the outflow passage 61 opens in the outer circumferential surface of the third plate 18.

A branch pipe 62 is connected to the first end of the inflow passage 60. The branch pipe 62 branches from the middle of the supply pipe 45. A first end of the branch pipe 62 is connected to the supply pipe 45. A second end of the branch pipe 62 is connected to the first end of the inflow passage 60. An intercooler 63 is provided in the branch pipe 62. The intercooler 63 cools air flowing through the branch pipe 62.

Some of the air flowing through the supply pipe 45 flows into the branch pipe 62. The air flowing through the branch pipe 62 is cooled by the intercooler 63. The air that has passed through the intercooler 63 has a temperature lower than the temperature of the air discharged into the second discharge chamber 42. The air cooled by the intercooler 63 is drawn into the motor chamber 25 through the inflow passage 60, the first insertion hole 17h, and the inner hole of the first bearing holding portion 26.

The first bearing 33 is cooled by air that passes through the inner hole of the first bearing holding portion 26. The rotating electric machine 11 is cooled by the air drawn into the motor chamber 25. The air drawn into the motor chamber 25 flows through the gap between the stator 54 and the rotor 53 and flows through the inner hole of the second bearing holding portion 27. The second bearing 34 is cooled by air that passes through the inner hole of the second bearing holding portion 27. The air that has passed through the inner hole of the second bearing holding portion 27 is discharged to the outside via the second insertion hole 18h and the outflow passage 61.

### Stator

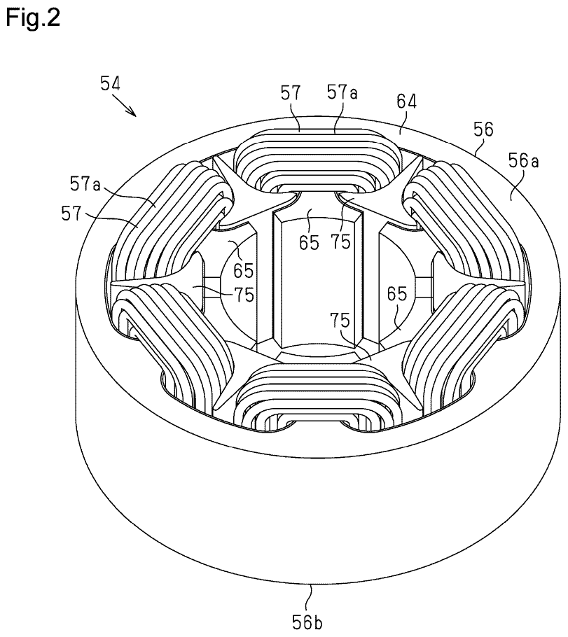

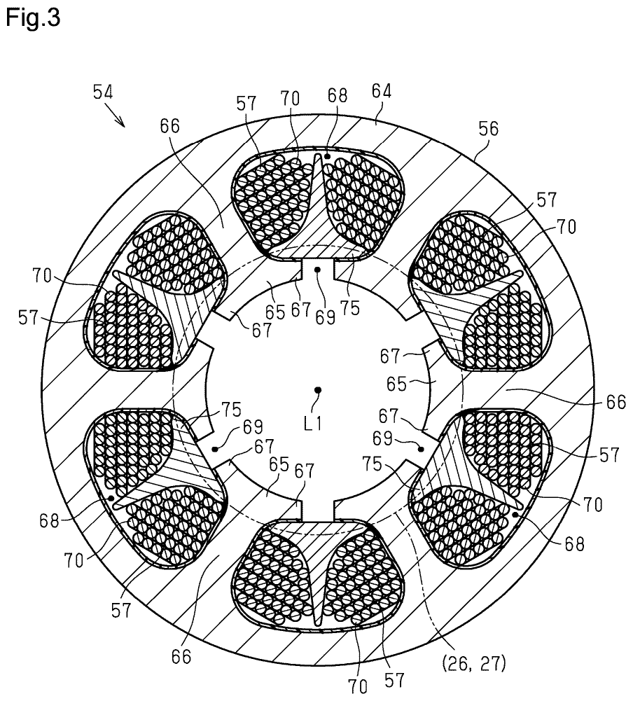

As shown in FIGS. 2 and 3, the stator core 56 includes a cylindrical yoke 64 and multiple teeth 65. Each tooth 65 extends from the inner circumferential surface of the yoke 64. The teeth 65 are spaced apart from each other in the circumferential direction of the yoke 64. Specifically, the teeth 65 are disposed at equal intervals in the circumferential direction of the yoke 64. Each tooth 65 extends from the inner circumferential surface of the yoke 64 toward an axis L1 of the stator core 56. Each tooth 65 has a distal surface at a side opposite to the yoke 64. The distal surface is an arcuate surface, which is curved arcuately. The distal surfaces of the teeth 65 are located on a concentric circle.

End faces on the opposite sides of the stator core 56 in the axial direction of the yoke 64 are flat. End faces on the opposite sides of each tooth 65 in the axial direction of the stator core 56 are flat. The length of the yoke 64 in the axial direction of the stator core 56 is equal to the length of each tooth 65 in the axial direction of the stator core 56. Each end face of the yoke 64 is positioned on the same plane as the end face on the corresponding side of each tooth 65. One of the opposite end faces of the yoke 64 and one of the opposite end faces of each tooth 65 form the first end face 56a of the stator core 56. The other one of the opposite end faces of the yoke 64 and the other one of the end faces of each tooth 65 form the second end face 56b of the stator core 56.

As shown in FIG. 3, each tooth 65 includes a tooth extension 66 and two flanges 67. The tooth extension 66 extends from the inner circumferential surface of the yoke 64 in a radial direction of the yoke 64. The tooth extension 66 is a section of each tooth 65 that extends from the inner circumferential surface of the yoke 64. The tooth extension 66 has a distal end at a side opposite to the yoke 64. The two flanges 67 project from the distal end of the tooth extension 66 toward opposite sides in the circumferential direction of the yoke 64.

The stator core 56 includes slots 68 between adjacent ones of the teeth 65 in the circumferential direction of the yoke 64. A slot opening 69, which is the gap between two of the flanges 67 adjacent to each other in the circumferential direction of the yoke 64, is continuous with the corresponding slot 68. Each slot opening 69 is a space between distal ends of adjacent ones of the flanges 67 in the circumferential direction of the yoke 64. Each coil 57 is formed by a winding 70 that is wound in a concentrated manner around the corresponding tooth 65 while passing through the corresponding slots 68. The coils 57 are thus partially located in the slots 68.

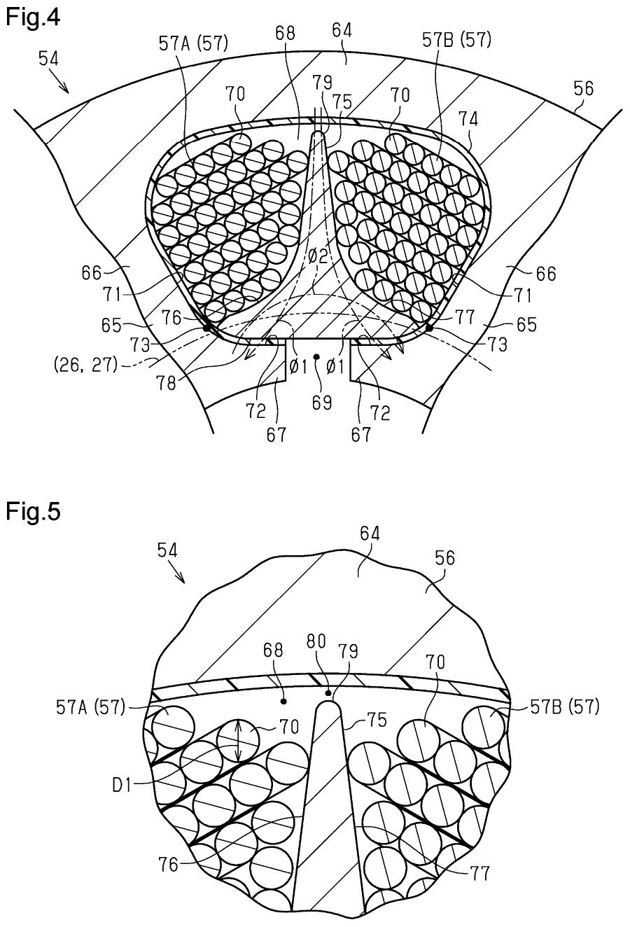

As shown in FIG. 4, each tooth extension 66 includes two tooth side surfaces 71. The tooth side surfaces 71 are located on opposite sides of the tooth extension 66 in the circumferential direction of the yoke 64. The tooth side surfaces 71 are continuous with the inner circumferential surface of the yoke 64. The tooth side surfaces 71 define the slots 68. Each flange 67 includes a flange surface 72. Each flange surface 72 is continuous with the corresponding tooth side surface 71. The end of the tooth side surface 71 at the side opposite to the inner circumferential surface of the yoke 64 is a boundary 73 between the tooth side surface 71 and the flange surface 72. In other words, the end of the flange surface 72 at the side opposite to the distal end of the flange 67 is the boundary 73 between the tooth side surface 71 and the flange surface 72. Each flange surface 72 extends from the corresponding tooth side surface 71 to the distal end of the flange 67. Each flange surface 72 extends arcuately from the boundary 73 and then extends flatly to the distal end of the flange 67. The flange surfaces 72 define the slots 68. Each slot 68 is a space defined by a part of the inner circumferential surface of the yoke 64, two of the tooth side surfaces 71, and two of the flange surfaces 72.

The stator 54 includes slot insulating sheets 74. The slot insulating sheets 74 are respectively inserted into the slots 68. Each slot insulating sheet 74 is disposed between the corresponding coils 57 and the stator core 56. The slot insulating sheet 74 insulates the stator core 56 from sections of the coils 57 arranged in the slot 68 from each other. The slot insulating sheet 74 is an elongated sheet that is curved in the shape of U in a transverse direction. The slot insulating sheet 74 is inserted into the slot 68 with the lengthwise direction agreeing with the axial direction of the stator core 56. The slot insulating sheet 74 extends along part of the inner circumferential surface of the yoke 64, the two tooth side surfaces 71, and the two flange surfaces 72, which form the slot 68. The slot insulating sheet 74 extends from a first end to a second end in the axial direction of the stator core 56.

### Insulating Members

As shown in FIGS. 2 and 3, an insulating member 75 is disposed in each slot 68. The insulating members 75 each have the shape of a triangular prism. The insulating members 75 are made of plastic. Each insulating member 75 is located in one of the slots 68 and between the coils 57, which are adjacent to each other in the circumferential direction of the yoke 64. The insulating member 75 insulates the coils 57, adjacent to each other in the circumferential direction of the yoke 64, from each other in the slot 68. The insulating member 75 is disposed in the slot 68 with the lengthwise direction of the insulating member 75 agreeing with the axial direction of the stator core 56. The opposite ends in the lengthwise direction of the insulating member 75 respectively project from the first end face 56a and the second end face 56b of the stator core 56. Thus, the length of the insulating member 75 in the lengthwise direction is longer than the length of the stator core 56 in the axial direction.

As shown in FIG. 4, each insulating member 75 includes a first coil supporting surface 76, a second coil supporting surface 77, a supported surface 78, and a radially outer end 79. The first coil supporting surface 76 faces one of the two coils 57 that are adjacent to each other in the circumferential direction of the yoke 64 in the associated slot 68. The second coil supporting surface 77 faces the other one of the two coils 57 adjacent to each other in the circumferential direction of the yoke 64 in the slot 68.

In the following description, one of the two coils 57 adjacent to each other in the circumferential direction of the yoke 64 in each slot 68 will simply referred to as a “first coil 57A” in some cases. The other one of the two coils 57 adjacent to each other in the circumferential direction of the yoke 64 in each slot 68 will simply referred to as a “second coil 57B” in some cases.

The first coil supporting surface 76 supports the first coil 57A. The first coil supporting surface 76 is in contact with the first coil 57A. The second coil supporting surface 77 supports the second coil 57B. The second coil supporting surface 77 is in contact with the second coil 57B.

The first coil supporting surface 76 supports the first coil 57A in a state in which the first coil 57A is disposed outward of the boundary 73 on the tooth 65 in the radial direction of the yoke 64. The second coil supporting surface 77 supports the second coil 57B in a state in which the second coil 57B is disposed outward of the boundary 73 on the tooth 65 in the radial direction of the yoke 64. Accordingly, the insulating member 75 supports the coils 57 in a state in which the coils 57 are disposed outward of the boundaries 73 on the teeth 65 in the radial direction of the yoke 64.

The first coil supporting surface 76 and the second coil supporting surface 77 are arcuately curved surfaces that are recessed toward each other. The first coil supporting surface 76 and the second coil supporting surface 77 extend toward the inner circumferential surface of the yoke 64 from the boundaries 73 on the teeth 65, around which the windings 70 of the corresponding coils 57 are wound. The distance between the first coil supporting surface 76 and the second coil supporting surface 77 decreases toward the inner circumferential surface of the yoke 64.

The supported surface 78 connects an end of the first coil supporting surface 76 located at a side opposite to the inner circumferential surface of the yoke 64 to an end of the second coil supporting surface 77 located at a side opposite to the inner circumferential surface of the yoke 64. The supported surface 78 includes parts each extending along the associated flange surface 72. The supported surface 78 extends in the slot 68 across the slot opening 69. The supported surface 78 closes the slot opening 69 from the inside of the slot 68. Thus, part of the supported surface 78 faces the interior of the slot opening 69. The supported surface 78 is supported by two flanges 67 with the slot insulating sheet 74 located in between. The insulating member 75 is thus supported by the two flanges 67. The first coil supporting surface 76 pushes the first coil 57A outward in the radial direction of the yoke 64, and the second coil supporting surface 77 pushes the second coil 57B outward in the radial direction of the yoke 64.

As shown in FIG. 5, the radially outer end 79 of the insulating member 75 connects the first coil supporting surface 76 and the second coil supporting surface 77 to each other in the vicinity of the inner circumferential surface of the yoke 64. The radially outer end 79 of the insulating member 75 connects an end of the first coil supporting surface 76 located close to the inner circumferential surface of the yoke 64 to an end of the second coil supporting surface 77 located close to the inner circumferential surface of the yoke 64. The radially outer end 79 is a sharp end of the insulating member 75 on the side opposite to the supported surface 78. The radially outer end 79 is spaced apart from the slot insulating sheet 74. A clearance 80 is thus formed between the radially outer end 79 and the slot insulating sheet 74. In the slot 68, the clearance 80 is located on the outer side of the radially outer end 79 in the radial direction of the yoke 64. The clearance 80 is smaller than an outer diameter D1 of the windings 70.

As shown in FIG. 4, the first bearing holding portion 26 and the second bearing holding portion 27 each include sections that respectively face, in the axial direction of the rotary shaft 50, the regions in the slots 68 that face the flange surfaces 72. The first bearing holding portion 26 and the second bearing holding portion 27 each include sections that respectively face, in the axial direction of the rotary shaft 50, radially inner sections of the insulating members 75, that is, sections that face sections including the supported surfaces 78. The first bearing holding portion 26 projects into the region surrounded by the first coil ends 57a such that the first bearing holding portion 26 faces the region in each slot 68 that faces the corresponding flange surfaces 72 in the axial direction of the rotary shaft 50. The second bearing holding portion 27 projects into the region surrounded by the second coil ends 57b such that the second bearing holding portion 27 faces the region in each slot 68 that faces the corresponding flange surfaces 72 in the axial direction of the rotary shaft 50.

### Operation of Embodiment

Operation of the embodiment will now be described.

The heat generated by the coils 57 is transferred to the peripheral wall 13b of the motor housing member 13, for example, through the teeth 65 and the yoke 64. The peripheral wall 13b of the motor housing member 13 is cooled by the coolant flowing through the coolant passage 13c. Thus, the heat generated by the coils 57 is efficiently dissipated to the peripheral wall 13b of the motor housing member 13 through the teeth 65 and the yoke 64.

As indicated by arrows in FIG. 4, in the stator 54 of the rotating electric machine 11, a leakage magnetic flux φ1 may be generated that flows from the inner circumferential surface of the yoke 64 toward the flanges 67 of the teeth 65 after passing through the space between the coils 57 adjacent to each other in the circumferential direction of the yoke 64. For example, if parts of the coils 57 are located on the flange surfaces 72 of the flanges 67, the leakage magnetic flux φ1 may flow through sections of the coil 57 on the flange surfaces 72. Also, as indicated by an arrow in FIG. 4, depending on the rotational position of the rotor 53, a leakage magnetic flux φ2 may be generated that flows over the slot opening 69 from one of flange portions 67 that are adjacent to each other in the circumferential direction of the yoke 64 to the other. For example, if part of each coil 57 is located on the flange surface 72 of each flange 67, the leakage magnetic flux φ2 may flow through the sections of the coils 57 on the flange surfaces 72. This generates eddy currents in the sections of the coils 57 on the flange surfaces 72, causing the sections of the coils 57 on the flange surfaces 72 to generate heat. The heat generated by the coils 57 lowers the output of the rotating electric machine 11.

In this regard, the insulating member 75 supports the coils 57 in a state in which the coils 57 are disposed outward of the boundaries 73 on the teeth 65 in the radial direction of the yoke 64. Thus, no parts of the coils 57 are located on the flange surfaces 72. Accordingly, even if the leakage magnetic flux φ1 is generated that flows from the inner circumferential surface of the yoke 64 toward the flanges 67 through the gap between the coils 57, adjacent to each other in the circumferential direction of the yoke 64, the leakage magnetic flux φ1 is prevented from flowing through part of the coils 57. Also, even if the leakage magnetic flux φ2 is generated that flows over the slot opening 69 from one of the flanges 67, adjacent to each other in the circumferential direction of the yoke 64, to the other, the leakage magnetic flux φ2 is prevented from flowing through part of the coils 57. This suppresses the generation of eddy currents in the coils 57 due to the leakage magnetic fluxes φ1, φ2.

### Advantages of Embodiment

The above-described embodiment has the following advantages.
(1) Each insulating member 75 supports the corresponding coils 57 in a state in which the coils 57 are disposed outward of the boundaries 73 between the tooth side surfaces 71 and the flange surfaces 72 in the radial direction of the yoke 64. There are no coils 57 on the inner side of the boundaries 73 in the radial direction of the yoke 64. Thus, no parts of the coils 57 are located on the flange surfaces 72. Accordingly, even if the leakage magnetic flux φ1 is generated that flows from the inner circumferential surface of the yoke 64 toward the flanges 67 of the teeth 65 through the gap between the coils 57, adjacent to each other in the circumferential direction of the yoke 64, the leakage magnetic flux φ1 is prevented from flowing through part of the coils 57. This suppresses the generation of eddy currents in the coils 57 due to the leakage magnetic flux φ1.
(2) The first coil supporting surface 76 and the second coil supporting surface 77 extend toward the inner circumferential surface of the yoke 64 from the boundaries 73 between the tooth side surfaces 71 and the flange surfaces 72. The distance between the first coil supporting surface 76 and the second coil supporting surface 77 decreases toward the inner circumferential surface of the yoke 64. This prevents the leakage magnetic flux φ1 from flowing into the coils 57, while maximizing the space for the coils 57 disposed in the slot 68.
(3) The clearance 80 exists in the slot 68 at the outer side of the insulating member 75 in the radial direction of the yoke 64. If the first coil supporting surface 76 and the second coil supporting surface 77 are extended so that the clearance 80 is minimized, the insulating member 75 easily insulates the coils 57, adjacent to each other in the circumferential direction in the slot 68, from each other. However, for example, if a design without the clearance 80 is employed, it may be difficult to place the insulating member 75 in the slot 68. On the other hand, if the clearance 80 is too large, the windings 70 of the coils 57, adjacent to each other in the slot 68 in the circumferential direction of the yoke 64, may pass through the clearance 80. This may hamper insulation between the adjacent coils 57. In this regard, the clearance 80 of the present embodiment is smaller than the outer diameter D1 of the windings 70. With this configuration, the windings 70 of the coils 57, adjacent to each other in the slot 68, do not pass through the clearance 80. This suppresses the generation of eddy currents in the coils 57 due to the leakage magnetic flux φ1, while ensuring insulation between the coils 57, adjacent to each other in the slot 68.
(4) Each insulating member 75 supports the corresponding coils 57 in a state in which the coils 57 are disposed outward of the boundaries 73 between the tooth side surfaces 71 and the flange surfaces 72 in the radial direction of the yoke 64. Since no parts of the coils 57 are located on the flange surfaces 72, no sections of the first coil ends 57a or the second coil ends 57b pass the flange surfaces 72 and project from the end faces of the stator core 56. This configuration allows the first bearing holding portion 26 to project into the region surrounded by the first coil ends 57a such that the first bearing holding portion 26 faces the region in each slot 68 that faces the corresponding flange surfaces 72 in the axial direction of the rotary shaft 50. This configuration also allows the second bearing holding portion 27 to project into the region surrounded by the second coil ends 57b such that the second bearing holding portion 27 faces the region in each slot 68 that faces the corresponding flange surfaces 72 in the axial direction of the rotary shaft 50. Thus, the first bearing holding portion 26 is readily disposed in the inner region surrounded by the first coil ends 57a. Further, the second bearing holding portion 27 is readily disposed in the inner region surrounded by the second coil ends 57b. As a result, the size of the motor-driven compressor 10 is readily reduced in the axial direction of the rotary shaft 50.
(5) Each insulating member 75 is supported by the corresponding flanges 67 located adjacent to each other with the slot opening 69 in between. Thus, the first coil supporting surface 76 pushes the first coil 57A outward in the radial direction of the yoke 64, and the second coil supporting surface 77 pushes the second coil 57B outward in the radial direction of the yoke 64. With this configuration, the winding 70 that forms the first coil 57A and the winding 70 that forms the second coil 57B are densely arranged. This improves the heat dissipation performance of the first coil 57A and the second coil 57B. Also, since the winding 70 that forms the first coil 57A and the winding 70 that forms the second coil 57B are densely arranged, the space factor of the coils 57 is increased.
(6) Each insulating member 75 supports the corresponding coils 57 in a state in which the coils 57 are disposed outward of the boundaries 73 between the tooth side surfaces 71 and the flange surfaces 72 in the radial direction of the yoke 64. Thus, no parts of the coils 57 are located on the flange surfaces 72. Thus, even if the leakage magnetic flux φ2 is generated that flows over the slot opening 69 from one of the flanges 67, adjacent to each other in the circumferential direction of the yoke 64, to the other, the leakage magnetic flux φ2 is prevented from flowing through part of the coils 57. This suppresses the generation of eddy currents in the coils 57 due to the leakage magnetic flux φ2.

### Modifications

The above-described embodiment may be modified as follows. The above-described embodiment and the following modifications can be combined as long as the combined modifications remain technically consistent with each other.

The first coil supporting surface 76 and the second coil supporting surface 77 do not necessarily need to extend toward the inner circumferential surface of the yoke 64 from the boundaries 73 on the teeth 65, around which the windings 70 of the corresponding coils 57 are wound. The distance between the first coil supporting surface 76 and the second coil supporting surface 77 does not necessarily need to decrease toward the inner circumferential surface of the yoke 64. In other words, the insulating member 75 may have any configuration as long as it supports the coils 57 in a state in which the coils 57 are disposed outward of the boundaries 73 on the teeth 65 in the radial direction of the yoke 64.

The radially outer end 79 of the insulating member 75 may be in contact with the slot insulating sheet 74. The clearance 80 does not necessarily need to be provided on the outer side of the radially outer end 79 of the insulating member 75 in the radial direction of the yoke 64.

The clearance 80 may be greater than or equal to the outer diameter D1 of the windings 70.

The first coil supporting surface 76 and the second coil supporting surface 77 do not necessarily need to be curved, but may have, for example, a stepped shape. The first coil supporting surface 76 and the second coil supporting surface 77 may have any configuration as long as they extend toward the inner circumferential surface of the yoke 64 from the boundaries 73 on the teeth 65, around which the windings 70 of the corresponding coils 57 are wound, and the distance between the first coil supporting surface 76 and the second coil supporting surface 77 decreases toward the inner circumferential surface of the yoke 64.

The insulating member 75 does not necessarily need to have the shape of a triangular prism. In other words, the shape of the insulating member 75 is not particularly limited as long as it supports the coils 57 in a state in which the coils 57 are disposed outward of the boundaries 73 on the teeth 65 in the radial direction of the yoke 64.

The supported surface 78 of the insulating member 75 may be supported by the flanges 67 while directly contacting the flanges 67 without the slot insulating sheet 74 in between.

The first bearing holding portion 26 does not necessarily need to project into the inner region surrounded by the first coil ends 57a.

The second bearing holding portion 27 does not necessarily need to project into the inner region surrounded by the second coil ends 57b. Separately from the insulating member 75, a phase-to-phase insulation sheet that insulates the coils 57, adjacent to each other in the circumferential direction of the yoke 64, from each other may be provided in each slot 68. In other words, the insulating member 75 may have any configuration as long as it supports the coils 57 in a state in which the coils 57 are disposed outward of the boundaries 73 between the tooth side surfaces 71 and the flange surfaces 72 in the radial direction of the yoke 64.

The motor-driven compressor 10 does not necessarily need to include the second impeller 52.

The motor-driven compressor 10 may include a turbine wheel in place of the second impeller 52.

The motor-driven compressor 10 is not limited to a centrifugal type, but may be, for example, a scroll type, a piston type, or a vane type. In other words, the motor-driven compressor 10 may be any type as long as it includes a compression mechanism that is driven by rotation of the rotary shaft 50 to compress fluid.

The motor-driven compressor 10 does not necessarily need to be mounted on a fuel cell electric vehicle. In other words, the motor-driven compressor 10 is not limited to the one that is mounted on a vehicle.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A stator for a rotating electric machine, comprising:
a stator core including a cylindrical yoke and multiple teeth extending from an inner circumferential surface of the yoke, the stator core including slots each located between adjacent ones of the teeth in a circumferential direction of the yoke; and
multiple coils respectively provided around the multiple teeth, each coil being formed by a winding that is wound in a concentrated manner around the corresponding one of the teeth while passing through the corresponding slots, wherein
each of the teeth includes:
a tooth extension extending from the inner circumferential surface of the yoke in a radial direction of the yoke; and
two flanges projecting from a distal end of the tooth extension toward opposite sides in the circumferential direction of the yoke,
the tooth extensions each include tooth side surfaces that are located on opposite sides of the tooth extension in the circumferential direction, the tooth side surfaces defining the slots,
each of the flanges includes a flange surface that extends from the corresponding one of the tooth side surfaces to a distal end of the flange, the flange surfaces defining the slots, and
an insulating member is arranged in each of the slots, the insulating member being configured to support the corresponding coils in a state in which each coil is arranged at a radially outer side of a boundary between the corresponding tooth side surface and the corresponding flange surface.

2. The stator for the rotating electric machine according to claim 1, wherein
each of the insulating members includes:
a first coil supporting surface that supports one of the two coils that are adjacent to each other in the circumferential direction in the corresponding slot; and
a second coil supporting surface that supports the other one of the two coils that are adjacent to each other in the circumferential direction in the corresponding slot, and
the first coil supporting surface and the second coil supporting surface each extend from the boundary toward the inner circumferential surface of the yoke, a distance between the first coil supporting surface and the second coil supporting surface decreasing toward the inner circumferential surface of the yoke.

3. The stator for the rotating electric machine according to claim 2, wherein
each insulating member includes a radially outer end that connects the first coil supporting surface and the second coil supporting surface to each other in a vicinity of the inner circumferential surface of the yoke, and
each slot includes a clearance on a radially outer side of the radially outer end, and the clearance being smaller than an outer diameter of the winding.

4. The stator for the rotating electric machine according to claim 1, wherein each insulating member supports the corresponding coils such that each coil is not located radially inward of the corresponding boundary.

5. A motor-driven compressor, comprising:
a rotary shaft;
a rotating electric machine configured to rotate the rotary shaft;
a housing that accommodates the rotating electric machine; and
a compression mechanism configured to be driven by rotation of the rotary shaft to compress a fluid, wherein
the rotating electric machine includes a stator,
the stator includes:
a stator core including a cylindrical yoke and multiple teeth extending from an inner circumferential surface of the yoke, the stator core including slots each located between adjacent ones of the teeth in a circumferential direction of the yoke; and
multiple coils respectively provided around the multiple teeth, each coil being formed by a winding that is wound in a concentrated manner around the corresponding one of the teeth while passing through the corresponding slots, wherein
each of the teeth includes:
a tooth extension extending from the inner circumferential surface of the yoke in a radial direction of the yoke; and
two flanges projecting from a distal end of the tooth extension toward opposite sides in the circumferential direction of the yoke,
the tooth extensions each include tooth side surfaces that are located on opposite sides of the tooth extension in the circumferential direction, the tooth side surfaces defining the slots,
each of the flanges includes a flange surface that extends from the corresponding one of the tooth side surfaces to a distal end of the flange, the flange surfaces defining the slots, and
an insulating member is arranged in each of the slots, the insulating member being configured to support the corresponding coils in a state in which each coil is arranged at a radially outer side of a boundary between the corresponding tooth side surface and the corresponding flange surface.

6. The motor-driven compressor according to claim 5, further comprising a bearing that rotatably supports the rotary shaft, wherein
the housing includes a tubular bearing holding portion that holds the bearing,
the coils include coil ends projecting from an end face of the stator core, and
the bearing holding portion projects into an inner region surrounded by the coil ends.
